(19) United States
(12) Patent Application Publication
(10) Pub. No.: US 2025/0066192 A1
(43) Pub. Date: Feb. 27, 2025

(54) CATALYST STRUCTURE FOR PREPARING SYNTHETIC GAS, AN APPARATUS FOR PREPARING SYNTHETIC GAS, AND A METHOD FOR PREPARING SYNTHETIC GAS USING THE SAME

(71) Applicants: HYUNDAI MOTOR COMPANY, Seoul (KR); KIA CORPORATION, Seoul (KR)

(72) Inventors: Haeun Jeong, Uiwang-si (KR); Ji-Hoon Jang, Suwon-si (KR); Kyung Soo Park, Seoul (KR); Pyung Soon Kim, Suwon-si (KR); Young Gul Hur, Yongin-si (KR)

(73) Assignees: HYUNDAI MOTOR COMPANY, Seoul (KR); KIA CORPORATION, Seoul (KR)

(21) Appl. No.: 18/536,599

(22) Filed: Dec. 12, 2023

(30) Foreign Application Priority Data
Aug. 24, 2023 (KR) 10-2023-0111502

(51) Int. Cl. C01B 3/40; B01J 35/30; B01J 35/57; B01J 35/60

(52) U.S. Cl. CPC C01B 3/40; B01J 35/394; B01J 35/57; B01J 35/60; C01B 2203/0227; C01B 2203/0261; C01B 2203/1241

(57) ABSTRACT

A catalyst structure for preparing synthetic gas includes a substrate including flow paths partitioned by partition walls, and catalytic material disposed on the surface of the partition walls of the substrate and including a metal oxide carrier and metal active particles supported on the metal oxide carrier, wherein the substrate includes silicon carbide (SIC), silicon nitride (Si₃N₄), a metallic silicon (Si)-silicon carbide (SIC) composite, a metallic silicon (Si)-silicon nitride (Si₃N₄) composite, or a combination thereof.

### CROSS-REFERENCE TO RELATED APPLICATION

This application claims priority to and the benefit of Korean Patent Application No. 10-2023-0111502 filed in the Korean Intellectual Property Office on Aug. 24, 2023, the entire contents of which are incorporated herein by reference.

### BACKGROUND

### (a) Field

The present disclosure relates to a catalyst structure for preparing synthetic gas, an apparatus for preparing synthetic gas including the same, and a method for preparing synthetic gas using the same.

### (b) Description of the Related Art

Gas containing hydrogen and carbon monoxide is a very important substance in automotive industry to supply hydrogen used in a fuel cell, steel industry to reduce iron ore, chemical industry to synthesize ammonia, methanol, and Fischer-Tropsch and manufacture other chemicals, etc.

In order to produce such a gas, a synthetic gas is produced from hydrocarbon through a reforming process, wherein a catalyst of a nickel-based alumina or a ruthenium-based alumina component is mainly used.

In a conventional reforming process, a pellet-type catalyst is filled in a reactor. However, the pellet-type catalyst may be damaged into pieces. The pellet-type catalyst may be damaged due to a mechanical impact, when loaded into the reactor, when thermally expanded and contracted during the shutdown after a reaction by heating to a reforming reaction temperature (about 600° C. or higher), or when coke is produced. The small pellet pieces resulting from these phenomena are filled in gaps between catalyst pellets and at the bottom end of the reactor, and thus may cause flow resistance against the reaction gas. In addition, a pellet made of alumina has low thermal conductivity and forms a temperature gradient within the reactor, promoting catalyst performance deterioration and the coke formation.

### SUMMARY

One aspect of the present disclosure provides a catalyst structure for preparing synthetic gas, which may improve the temperature gradient within a catalyst layer by improving heat transfer performance, reduce a pressure loss within the catalyst layer and flow resistance of the reaction gas, and achieve excellent long-term durability.

A catalyst for preparing synthetic gas according to one aspect includes a substrate including flow paths partitioned by partition walls, and catalytic material disposed on the surface of the partition walls of the substrate and including a metal oxide carrier and metal active particles supported on the metal oxide carrier, wherein the substrate includes silicon carbide (SiC), silicon nitride (Si₃N₄), a metallic silicon (Si)-silicon carbide (SiC) composite, a metallic silicon (Si)-silicon nitride (Si₃N₄) composite, or a combination thereof.

The catalytic material may be coated on inner walls of the flow paths of the substrate.

The substrate may have a honeycomb shape or a monolithic shape.

The catalyst structure may have a thermal conductivity of 10 W/mK or more.

The partition walls of the substrate may have a plurality of pores.

The partition walls of the substrate may have a porosity in a range of 10% to 80%.

The catalytic material may be included in an amount in a range of 20 g to 300 g per 1 L of volume of the catalyst structure.

The metal active particles may include nickel (Ni), cobalt (Co), rhodium (Rh), ruthenium (Ru), iridium (Ir), palladium (Pd), platinum (Pt), gold (Au), iron (Fe), an alloy thereof, or a combination thereof.

The metal oxide carrier may include alumina (Al₂O₃), silica (SiO₂), magnesia (MgO), magnesium aluminate (MgAl₂O₄), zirconia (ZrO₂), ceria (CeO₂), lantana (La₂O₃), yttria (Y₂O₃), or a combination thereof.

The metal active particles may be included in an amount in a range of 5wt. % to 30 wt. % based on a total weight of the catalytic material.

An apparatus for preparing synthetic gas according to another aspect includes a reactor tube including the above-described catalyst structure for generating synthetic gas.

The flow paths of the catalyst structure may be arranged along the longitudinal direction of the reactor tube.

The reaction gas may be configured to pass through the channels of the catalyst structure.

The catalyst structure may be in direct contact with the inner wall of the reactor tube.

The reaction gas may be configured to not pass between the catalyst structure and the inner wall of the reactor tube.

According to another aspect, a method for preparing synthetic gas includes injecting a reaction gas and an oxidizing agent into the flow path of the above-described catalyst structure for preparing synthetic gas. The method further includes reforming the reaction gas through an endothermic reaction to prepare the synthetic gas.

The reaction gas may include a C1 to C20 alkane, a C1 to C20 alkene, a C1 to C20 alkyne, ammonia (NH₃), formaldehyde (HCO₂H), methanol (CH₃OH), or a combination thereof.

The oxidizing agent may include carbon dioxide (CO₂), steam (H₂O), oxygen (O₂), or a combination thereof.

According to embodiments, the catalyst structure for preparing synthetic gas may secure improved heat transfer performance to reduce the temperature gradient in the catalyst layer and thus improve catalyst performance, reduce the pressure loss within the catalyst layer and flow resistance of the reaction gas, and suppress sintering of active metals in the catalyst to achieve the long-term durability.

### BRIEF DESCRIPTION OF THE DRAWINGS

FIG. 1 is a perspective view schematically showing a catalyst structure for preparing synthetic gas according to an embodiment.

FIG. 2 is a cross-sectional view cut perpendicular to the longitudinal direction of the flow paths in FIG. 1 and is an enlarged cross-sectional view showing the flow paths in an enlarged manner.

FIG. 3 is a graph showing the results of evaluating the reforming performance of the catalyst structures prepared in Example 1 and Comparative Examples 1 to 3 .

FIG. 4 is a graph showing the results of evaluating the reforming performance of the catalyst structures prepared in Example 1, Example 6, and Comparative Example 3.

FIG. 5 is a graph showing the results of evaluating the reforming performance of the catalyst structures prepared in Examples 1 to 4.

FIG. 6 is a graph showing the results of evaluating the reforming performance of the catalyst structures prepared in Examples 1 and 5.

FIG. 7 is a graph showing the results of evaluating the reforming performance of the catalyst structures prepared in Example 1 and Examples 7 to 9.

### DETAILED DESCRIPTION

The advantages, features, and aspects to be described hereinafter will become apparent from the following description of the embodiments with reference to the accompanying drawings, which is set forth hereinafter. However, the embodiments should not be construed as being limited to the embodiments set forth herein. Although not specifically defined, all of the terms including the technical and scientific terms used herein have meanings understood by ordinary persons skilled in the art. The terms defined in a generally-used dictionary may not be interpreted ideally or exaggeratedly unless clearly defined.

In addition, unless explicitly described to the contrary, the word “comprise,” and variations such as “comprises” or “comprising,” will be understood to imply the inclusion of stated elements but not the exclusion of any other elements.

Further, the singular includes the plural unless mentioned otherwise.

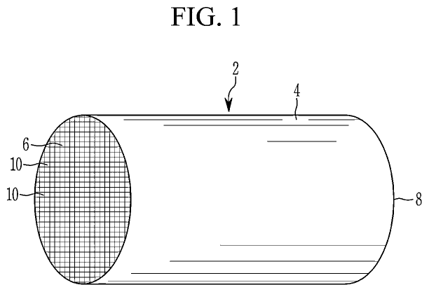

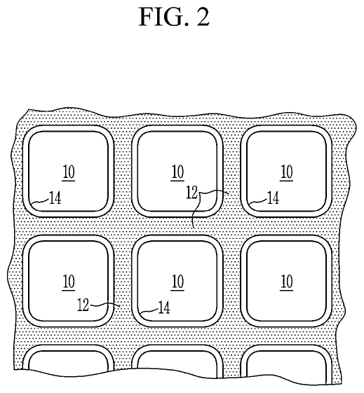

FIG. 1 is a perspective view schematically showing a catalyst structure for preparing synthetic gas according to an embodiment. FIG. 2 is a cross-sectional view cut perpendicular to the longitudinal direction of the flow paths in FIG. 1 and is an enlarged cross-sectional view showing the flow paths in an enlarged manner.

Hereinafter, referring to FIGS. 1 and 2, a catalyst structure for preparing synthetic gas is described.

The catalyst structure for preparing synthetic gas includes a substrate 2 and catalytic material 14 disposed on the substrate 2.

The substrate 2 includes flow paths 10 partitioned by partition walls 12.

For example, the substrate 2 may have a honeycomb shape or a monolithic shape. In other words, as shown in FIGS. 1 and 2, the substrate 2 may have a cylindrical shape, a cylindrical outer surface 4, an upstream end 6, and a downstream end 8 corresponding to the upstream end 6. The substrate 2 may have a plurality of the fine parallel flow paths 10 formed inside.

As shown in FIG. 2, the flow paths 10 are defined by the partition walls 12 and extend from the upstream end 6 to the downstream end 8 in a longitudinal direction. The partition walls 12 may be arranged so that the flow paths 10 may have a substantially regular cross-section shape, for example, a polygon such as a triangle, a quadrangle, a hexagon, an octagon, and the like, a circle, or an ellipse.

The substrate 2, (e.g., the partition walls 12 of the substrate 2 may include a material having excellent heat transfer performance. For example, the material having excellent heat transfer performance may be a material with thermal conductivity of greater than or equal to about 10 W/mK. Examples of this material may include silicon carbide (SIC), silicon nitride (Si₃N₄), a metallic silicon (Si)-silicon carbide (SIC) composite, a metallic silicon (Si)-silicon nitride (Si₃N₄) composite, or a combination thereof.

The catalyst structure, which includes the material having excellent heat transfer performance, may improve heat transfer performance and thus reduce a temperature gradient in a catalyst layer to improve performance of a catalyst and reduce a pressure loss within the catalyst layer and flow resistance of a reaction gas.

Accordingly, the catalyst structure may have thermal conductivity of greater than or equal to 10 W/mK, for example, greater than or equal to 11 W/mK, greater than or equal to 12 W/mK, greater than or equal to 13 W/mK, greater than or equal to 14 W/mK, greater than or equal to 15 W/mK, greater than or equal to 16 W/mK, or greater than or equal to 17 W/mK, and less than or equal to 100 W/mK, for example less than or equal to 90 W/mK, less than or equal to 80 W/mK, less than or equal to 70 W/mK, or less than or equal to 60 W/mK. When the catalyst structure has thermal conductivity of greater than or equal to 10 W/mk, the temperature gradient may be reduced in the catalyst layer, increasing a conversion rate of the reaction gas.

The partition walls 12 of the substrate 2 may be porous. In other words, the partition walls 12 of the substrate 2 may have a plurality of pores. The partition walls 12 of the substrate 2 may have porosity in a range of 10% to 80% or in a range of 20% to 70%. When the partition walls 12 of the substrate 2 has porosity of less than 10%, the catalytic material may be coated in a smaller area and thus not well dispersed, but when the porosity is greater than 80%, thermal conductivity of the catalyst structure may be lowered.

The catalytic material 14 is disposed on the surface of the partition walls 12 of the substrate 2. For example, the catalytic material 14 may be coated on the inner walls of the flow paths 10 of the substrate 2. However, the flow paths 10 are not closed by coating the catalytic material 14 but may pass a fluid, for example, the reaction gas. The catalytic material 14 may be included in an amount in a range of 20 g to 300 g, in a range of 30 g to 300 g, in a range of 20 g to 250 g, or in a range of 30 g to 250 g per about 1 L of a volume of the catalyst structure. When the coating amount of the catalytic material 14 is less than 20 g per 1 L of the volume of the catalyst structure, the catalyst may be not sufficient to convert the reaction gas, but when the coating amount is greater than 300 g per 1 L of the volume of the catalyst structure, the catalyst may act as a layer interfering with heat conduction, adversely affecting performance.

The catalytic material 14 includes a metal oxide carrier and metal active particles supported on the metal oxide carrier.

For example, the metal oxide carrier may include alumina (Al₂O₃), silica (SiO₂), magnesia (MgO), magnesium aluminate (MgAl₂O₄), zirconia (ZrO₂), ceria (CeO₂), lantana (La₂O₃), yttria (Y₂O₃), or a combination thereof.

The metal active particles may include nickel (Ni), cobalt (Co), rhodium (Rh), ruthenium (Ru), iridium (Ir), palladium (Pd), platinum (Pt), gold (Au), iron (Fe), an alloy thereof, or a combination thereof. These metals may be appropriately combined to improve carbon deposition, but among them, noble metals may deteriorate economic feasibility.

The metal active particles may be included in an amount in a range of 5 wt. % to 30 wt. %, in a range of 5 wt. % to 20 wt. %, or in a range of 10 wt. % to 20 wt. % based on a total weight of a catalyst. When the metal active particles are used in an amount of less than 5 wt. %, the metal active particles may not be sufficient to convert the reaction gas, deteriorating catalyst performance. When the amount of the metal active particles is greater than 30 wt. %, during the reaction, the metal active particles may be easily sintered, and carbon is deposited, thereby deteriorating performance and life-span of the catalyst due to the coke formation reaction and the particle agglomeration phenomenon.

Herein, the metal active particles may include at least some oxides of the metal active particles. When the catalyst is prepared by drying and firing after impregnating a precursor of the metal active particles in the metal oxide carrier, the metal active particles are partially reduced and oxidized, producing the oxides of the metal active particles in addition to the metal active particles on the catalyst surface.

Optionally, a metal oxide coating layer may be disposed on the metal oxide carrier surface. The metal oxide coating layer brings about a space confinement effect between the metal oxide carrier and the metal oxide coating layer to prevent the metal active particles from growth and agglomeration during the reaction of synthetic gas.

The metal oxide coating layer may include SiO₂, Al₂O₃, MgO, MgAl₂O₄, La₂O₃, CeO₂, ZrO₂, SiC, indium tin oxide (ITO), fluorine-doped tin oxide (FTO), or a combination thereof, (e.g.,, SiO₂ or Al₂O₃).

The metal oxide coating layer may be included in an amount in a range of 0.5 wt. % to 10 wt. %, in a range of 1 wt. % to 8 wt. %, in a range of 1 wt. % to 7 wt. %, or in a range of 1 wt. % to 5 wt. % based on a total weight of the catalyst. When the metal oxide coating layer is included in an amount of less than 0.5 wt. %, since the coating effect may hardly be obtained, the metal active particles may be sintered or increasingly agglomerated, and when included in an amount of greater than 10 wt. %, the content of the metal active particles may be reduced, and material transfer resistance may be rather increased due to a thickness of the metal oxide coating layer.

The catalytic material, when the metal active particles, which an active material, structurally well supported on the metal oxide carrier and prevented from agglomeration by the metal oxide coating layer, may have durability against the carbon deposition.

For example, a method of manufacturing this catalytic material may include supporting the metal active particles on the porous metal oxide carrier and forming the metal oxide coating layer on the porous metal oxide carrier surface.

The supporting the metal active particles may be performed by coating a metal active particle precursor solution on the porous metal oxide carrier and drying it and then, firing it.

Specifically, the metal active particle precursor solution may be prepared by adding the precursor of the metal active particles to a solvent. The precursor of the metal active particles may include nitrates, sulfates, acetates, chlorides, oxides, acetylacetonates, or combinations thereof of the metal active particles. The solvent may include distilled water, ethanol, methanol, ethylene glycol, propylene glycol, isopropyl alcohol, or a combination thereof.

The drying may be performed at a temperature in a range of 60° C. to 90° C. When the drying temperature is less than 60° C., since the solvent may not be all removed, the metal active particles may leak out of pores during the firing. When the drying temperature is greater than 90° C., the drying occurs so fast that the metal active particles may leak out of the pores during the drying.

The firing may be performed at a temperature in a range of 400° C. to 1000° C. for 1 hour to 6 hours. When the firing temperature is less than 400° C., or the firing time is less than 1 hour, the precursor solution may not be converted into the metal active particles. When the firing temperature is greater than 1000° C., or the firing time is greater than 6 hours, the metal active particles may be formed to be extremely large, reducing a specific surface area of the catalyst.

On the other hand, oxides of the metal active particles may be generated during manufacture of the catalyst. For example, in the process of preparing the catalyst for preparing synthetic gas by bonding the metal active particles onto the carrier and drying them and forming the metal oxide coating layer and firing it, since the metal active particles are partially reduced and oxidized, some of oxides of the metal active particles may be included on the carrier surface in addition to the metal active particles on the surface.

The forming the metal oxide coating layer may be performed by mixing the carrier supporting the metal active particles and the metal oxide precursor and firing them.

For example, after dispersing the metal active particle-supporting carrier in the solvent, a surfactant (e.g., cetyltrimethylammonium bromide (CTAB)) is added thereto and then, ultrasonicated to attach the surfactant onto the metal active particle-supporting carrier surface. Subsequently, the metal oxide precursor (e.g., aluminum isopropoxide) is injected thereinto and then, stirred for a coating reaction, and fired to prepare the catalyst.

In this way, when the surfactant is used in the forming the metal oxide coating layer, the metal oxide coating layer may include mesopores with a pore size in a range of 2 nm to 50 nm. The metal oxide coating layer has mesopores with too large a pore size, structural stability of the catalyst may be deteriorated, but the mesopores have too a small pore size, accessibility between the metal active particles and the reaction gas may be deteriorated.

The surfactant may include non-ionic, cationic, or anionic surfactants in addition to the cetyltrimethylammonium bromide, but types thereof is not particularly limited.

The firing may be performed at a temperature in a range of 400° C. to 1000° C. for 1 hour to 6 hours. When the firing temperature is less than 400° C., or the firing time is less than about 1 hour, the surfactant may not be completely removed. When the firing temperature is greater than 1000° C., or the firing time is greater than 6 hours, the specific surface area of the catalyst may be extremely reduced.

For example, the prepared catalytic material may be coated on inner walls of the flow paths of the substrate.

In order to coat the catalytic material on the substrate, the prepared catalytic material may be dispersed in an aqueous solution first, and then, a binder and an organic material are added thereto to prepare slurry and then, optionally grinded by using a ball mill. An amount of the catalyst to be coated may be calculated as a mass of the catalyst to be coated per volume of the substrate in order to adjust a concentration of the slurry. Subsequently, the slurry is coated on the substrate and then dried and fired to manufacture a catalyst structure.

However, the method of manufacturing the catalyst structure is not limited, as described above, to preparing the catalytic material in powder form, preparing it into slurry, and coating the slurry on the substrate. Alternatively, the method may include coating the metal oxide carrier on the substrate, supporting the metal active particles thereon and optionally, forming the metal oxide coating layer. In some examples, the metal active particles may be directly supported on the substrate, and optionally, the metal oxide coating layer may be formed thereon.

According to another example embodiment, an apparatus for preparing synthetic gas includes the aforementioned catalyst structure for preparing synthetic gas.

For example, the apparatus for preparing synthetic gas includes a tube-shaped reactor tube, and the catalyst structure may be filled in the reactor tube. Herein, the catalyst structure may be disposed so that the flow paths of the catalyst structure may be arranged along a longitudinal direction of the reactor tube. Accordingly, when the reaction gas is supplied into the reactor tube, the reaction gas may pass through the flow paths of the catalyst structure.

Herein, the catalyst structure may be in direct contact with an inner wall of the reactor tube to prevent channeling of the reaction gas, in which the reaction gas passes between the catalyst structure and the inner wall of the reactor tube. For example, the catalyst structure may have a substantially equivalent diameter to an interior diameter of the reactor tube. When the diameter of the catalyst structure is smaller than the interior diameter of the reactor tube, the channeling of the reaction gas may occur, increasing a nonreaction gas and thereby, deteriorating catalyst performance.

In addition, a method for preparing synthetic gas according to another example embodiment includes injecting the reaction gas and an oxidizing agent into the flow paths of the catalyst structure for preparing synthetic gas and reforming the reaction gas through an endothermic reaction.

For example, the method for preparing synthetic gas is a method of adding carbon dioxide, a major greenhouse gas, to methane and steam, raw materials for conventional steam reforming, to convert it to synthetic gas, for example, performing combined steam and carbon dioxide reforming of methane, which is expressed by Reaction Scheme 1, to prepare synthetic gas including carbon monoxide and hydrogen.

3CH₄+CO₂+2H₂O⇄8H₂+4CO [Reaction Scheme 1]

The reaction gas may include a C1 to C20 alkane, a C1 to C20 alkene, a C1 to C20 alkyne, ammonia (NH₃), formaldehyde (HCO₂H), methanol (CH₃OH), or a combination thereof.

The oxidizing agent may include carbon dioxide (CO₂), steam (H₂O), oxygen (O₂), or a combination thereof.

In certain examples,, the reaction gas may include methane, carbon dioxide as an oxidizing agent, and water, and the synthetic gas may include hydrogen and carbon monoxide. For example, the water may be included in the form of steam into the reaction gas.

The synthetic gas-manufacturing method is to supply the reaction gas by adjusting a mole ratio of the reaction gas in order to obtain synthetic gas with a required composition.

The reaction gas may include methane and an oxidizing agent (carbon dioxide and water) in a mole ratio in a range of 1:1 to 1:3 or a mole ratio in a range of 1:1.2 to 1:2.

When the oxidizing agent has a mole ratio of less than 1 (e.g., a ratio of 1:0.5), a conversion rate of the methane may be lowered, but the carbon deposition may increase, causing deactivation of the catalyst. When the oxidizing agent has a mole ratio is greater than 3 (e.g., a ratio of 1:5), a conversion rate of carbon dioxide may be lowered, and hydrogen may be less generated according to less oxidization of the surface of the catalyst active material. The mole ratio of the methane and the oxidizing agent ranging from 1:1.2 to 1:2 may be optimal, when considering the conversion rate of the reaction gas, a ratio of H₂/CO in the produced gas, and the carbon deposition.

The oxidizing agent may include carbon dioxide and water in a mole ratio in a range of 0.2:1.5 to 1.2:0.2. When the water has a mole ratio of greater than 1.5 (e.g., 0.2:2), the deactivation of the catalyst may be promoted due to unreacted residual steam.

On the other hand, in a case of the mixed reforming, the reaction gas may further include nitrogen in addition to methane, carbon dioxide, and water. The nitrogen may be included relative to methane in a mole ratio in a range of 1:1 to 1:3. The nitrogen may be used as a diluent to reduce a temperature fluctuation range of the catalyst layer during the reaction.

The reaction gas may be supplied at a space speed in a range of 500/h to 20000/h or in a range of 1000/h to 10000/h. The supply speed of the reaction gas may be increased proportionally to a size of a mixed reforming reactor and capacity of a catalyst.

A reaction temperature and a pressure of the mixed reforming may be appropriately adjusted according to a composition of a required synthetic gas. For example, the mixed reforming reaction may have a temperature condition in a range of 600° C. to 1000° C., in a range of 650° C. to 900° C., or in a range of 800° C. to 950° C. When the reaction temperature is less than 600° C., the conversion rate of carbon dioxide may be significantly lowered, and CO₂ may be rather produced. When the reaction temperature is greater than 1000° C., heat energy is inefficiently consumed, causing thermal deactivation of the catalyst.

In addition, the pressure condition of the mixed reforming reaction may be in a range of 0.5 atm to 20 atm, or in a range of 1 atm to 10 atm. When the reaction pressure is greater than 20 atm, the conversion rate of the reaction gas may be lowered, thereby changing the H₂/CO ratio.

According to the method for preparing synthetic gas by using a catalyst, the conversion rate of methane and/or carbon dioxide to the reaction gas may be in a range of 30 mol % to 99.9 mol %, which may be stable against the carbon deposition at 900° C. up to 100 hours.

Hereinafter, specific examples of the present disclosure are presented. However, the examples described below are only for specifically illustrating or explaining the present disclosure, and the scope of the disclosure is not limited thereto.

### PREPARATION EXAMPLE: PREPARATION OF CATALYST STRUCTURE

### Example 1

### (1) Supporting Nickel on Metal Oxide Carrier

The nickel, which is an active metal particle, is supported on a commercial alumina carrier. In order to support 12 wt. % of Ni on the alumina carrier, a precursor solution prepared by dissolving nickel nitrate hexahydrate (Ni(NO₃)₂6H₂O) in distilled water is applied thereon and then, dried in a convection oven at 80° C. overnight. The dried mixture is fired at 800° C. under an air atmosphere for 2 hours (at a temperature increase rate of 1° C./min).

### (2) Formation of Metal Oxide Coating Layer

1 g of the prepared catalyst is dispersed by ultrasonication in 9 mL of ethanol. Subsequently, a solution prepared by dissolving 0.3 g of cetyltrimethylammonium bromide (Alfa-Aesar, 98%, hereinafter, CTAB) in 8 mL of ethanol and 0.6 mL of ammonia (NH₄OH, Duksan Science, 25 to 30%) is added thereto and then, additionally treated with ultrasonic waves for 10 minutes to attach CTAB on the catalyst surface.

While the mixture is fervently stirring at room temperature, 0.1 mL of aluminum isopropoxide (AIP, Samchun Chemicals, 98%) is injected thereinto by a syringe pump at 48 mL/h and then, continuously stirred for 5 hours to keep the coating reaction. A coated product therefrom is filtered, washed with ethanol, dried at 80° C. in a convention oven overnight, and fired at 550° C. under an air atmosphere for 2 hours to prepare a catalytic material.

### (3) Coating the Catalytic Material on a Substrate

The prepared catalytic material is dispersed in an aqueous solution, and a binder and an organic material are added thereto to make it in a slurry state and then, pulverized by using a ball mill. As for a substrate, a honeycomb substrate including silicon carbide (SiC), having thermal conductivity of 45 W/mK and porosity of partition walls of 42% is used. A concentration of the catalytic material is controlled to have 50 g of a coating amount per 1 L of a volume of the honeycomb substrate. Subsequently, the slurry of the catalytic material is coated on the honeycomb substrate, dried, and fired at 900° C. to manufacture a catalyst structure.

Additionally, an apparatus for preparing synthetic gas may be configured so that the manufactured catalyst structure may be in contact with an inner wall of a reactor tube with a diameter of 1 inch to prevent channeling of reaction gas.

### Example 2

A catalyst structure is manufactured in the same manner as in Example 1 except that the coating amount of the catalytic material is changed into 20 g per 1 L of the volume of the substrate.

### Example 3

A catalyst structure is manufactured in the same manner as in Example 1 except that the coating amount of the catalytic material is changed into 100 g per 1 L of the volume of the substrate.

### Example 4

A catalyst structure is manufactured in the same manner as in Example 1 except that the coating amount of the catalytic material is changed into 250 g per 1 L of the volume of the substrate.

### Example 5

A catalyst structure is manufactured in the same manner as in Example 1 except that the amount of Ni supported on the carrier is changed into 20 wt. %.

### Example 6

A catalyst structure is manufactured in the same manner as in Example 1 except that a honeycomb substrate having thermal conductivity of 17 W/mK and porosity of partition walls of 60.5% is used.

### Comparative Example 1

12 wt. % of an Ni precursor of a catalyst active material is supported on a commercial alumina carrier. After drying it in a convention oven overnight, an alumina precursor for overlayer coating is melted and impregnated therein and then, fired at 900° C. to manufacture an Ni-based Al₂O₃ pellet (5×5 mm, thermal conductivity: 14 W/mk), and then, an apparatus for preparing synthetic gas is configured by filling the pellet in a reactor tube to the same height to form a catalyst layer as in Example 1.

For reference, in Table 1, the Ni content of Example 1 is an Ni content of the catalytic material to be coated, but the content of Comparative Example 1 is a total Ni content of the pellet catalyst.

### Comparative Example 2

A catalyst structure is manufactured in the same manner as in Example 1 except that a cordierite substrate with thermal conductivity of 2 W/mK and porosity of 35% in partition walls is used.

### Comparative Example 3

A catalyst structure is manufactured in the same manner as in Example 1 except that an FeCr alloy monolith substrate with thermal conductivity of 16 W/mK is used.

### Example 7

An apparatus for preparing synthetic gas is manufactured in the same manner as in Example 1 except that the reactor tube has a larger interior diameter than the catalyst structure, so that the inner wall of the reactor tube may not be in contact with the catalyst structure, but the catalyst structure may be supported by a mesh ring disposed at the bottom of the catalyst structure. Herein, the mesh ring is thick enough to slightly support the interior diameter of the reactor tube and the catalyst structure and to prevent channeling of the reaction gas.

### Example 8

An apparatus for preparing synthetic gas is manufactured in the same manner as in Example 1 except that the reactor tube has a larger interior diameter than the catalyst structure so that the catalyst structure may not be in contact with the inner wall of the reactor tube, and the catalyst structure is surrounded with a ceramic mat so that the catalyst structure may be fixed inside the reactor tube, in order to prevent channeling of the reaction gas.

### Example 9

An apparatus for preparing synthetic gas is manufactured in the same manner as in Example 1 except that the reactor tube has a larger interior diameter than the catalyst structure so that the catalyst structure may not be contact with the inner wall of the reactor tube, thereby allowing channeling of the reaction gas.

### Experimental Example 1: Measurement of Characteristics of Catalyst Structure

### (1) Measurement of Thermal Conductivity

Thermal conductivity is an amount of heat moving through a unit area when there is a temperature difference of 1° C. per unit length (thickness), which is a coefficient indicating how easy heat transfers due to the temperature difference within a material. The unit in general indicates W/m·K, and the larger thermal conductivity, the larger heat transfer and the easier heat transfer.

For example, the thermal conductivity of a honeycomb substrate may be measured by using a laser flash method. The laser flash method is performed by shooting laser light on the surface of a sample to measure an amount of heat coming from the rear surface of the sample and its time and deriving specific heat (Cp) and thermal diffusivity (α) therefrom, which are used to calculate thermal conductivity according to Equation 1.

Thermal conductivity of the substrates used in the preparation examples is measured, and the results are shown in Table 1.

$$Thermal conductivity : λ = α \cdot Cp \cdot ρ ( ρ : density ) \qquad [ Equation 1 ]$$

### (2) Composition Analysis of Catalytic Material

Each of the catalytic materials to be coated on the manufactured catalyst structure is checked with respect to a composition through X ray fluorescent analysis (XRF) to measure each amount of metal active particles and a metal oxide carrier, and the results are shown in Table 1.

TABLE 1

| | | Composition | | Properties | |
|---|---|---|---|---|---|
| | | | Catalyst | Substrate | |
| | | Ni | coating | thermal | |
| | Type of | content | amount | conductivity | Porosity |
| | substrate | (wt. %) | (g/L) | (W/mK(RT)) | (%) |
| Example 1 | SiC | 12 | 50 | 45 | 42 |
| Example 2 | SiC | 12 | 20 | 45 | 42 |
| Example 3 | SiC | 12 | 100 | 45 | 42 |
| Example 4 | SiC | 12 | 250 | 45 | 42 |
| Example 5 | SiC | 20 | 50 | 45 | 42 |
| Example 6 | SiC | 12 | 50 | 17 | 60.5 |
| Comparative | Al₂O₃ pellet | 12 | — | 14 | — |
| Example 1 | | | | | |
| Comparative | Cordierite | 12 | 50 | 2 | 35 |
| Example 2 | | | | | |
| Comparative | Metal | 12 | 50 | 16 | — |
| Example 3 | (FeCr alloy) | | | | |

### Experimental Example 2: Evaluation of Reforming Performance

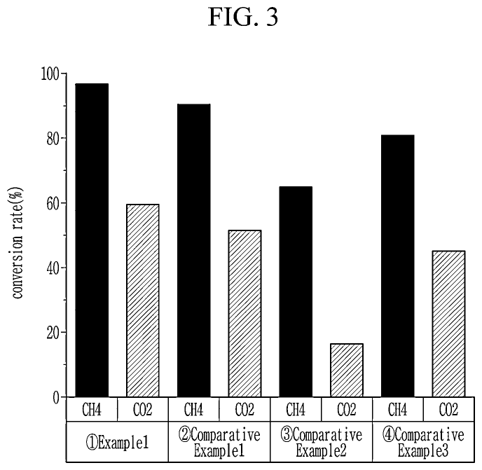

Methane as a reaction gas and carbon dioxide and steam as an oxidizing agent are mixed and reformed. The manufactured catalyst structure is coated in a reactor tube and then, heated to 900° C. under a hydrogen atmosphere and reduced for 1 hour. Subsequently, CH₄:CO₂:H₂O=1:0.5:1 are injected into the reactor at a space velocity (SV) of 6000/h. Herein, a temperature is set at 900° C., and a pressure is set at 1 bar. The reformation performance evaluation results are shown in FIGS. 3 to 7.

FIG. 3 is a graph showing the results of evaluating the reforming performance of the catalyst structures prepared in Example 1 and Comparative Examples 1 to 3.

Referring to FIG. 3, reformation performance according to types of substrates may be compared. Example 1, which uses a substrate with the highest thermal conductivity, exhibits a high conversion rate of methane and carbon dioxide. On the other hand, in addition to the thermal conductivity, the reforming performance may be affected by a flow path according to a shape and a size of a substrate or a pellet, a material constituting a catalyst, etc.

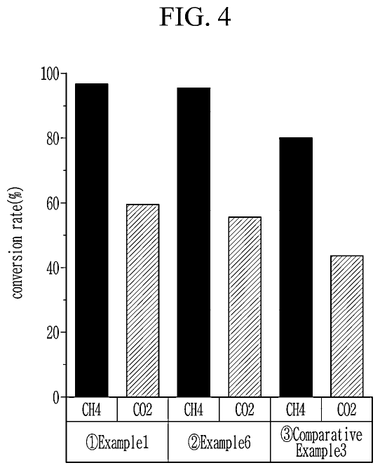

FIG. 4 is a graph showing the results of evaluating the reforming performance of the catalyst structures prepared in Examples 1 and 6 and Comparative Example 3.

Referring to FIG. 4, reforming performance according to thermal conductivity of a SiC substrate may be compared. Comparing the reforming performance evaluation results of Examples 1 and 6 using the same type of substrate material but exhibiting different thermal conductivity, Example 6 exhibits higher porosity than Example 1 and thus has an advantage in dispersing a catalytic material, but Example 1 exhibits higher thermal conductivity. Example 1 also exhibits higher reforming performance than Example 6, which is not large difference. Comparative Example 3 exhibits similar thermal conductivity to Example 6 but a large difference in the reforming performance. This confirms that the SiC substrate material plays an important role in the reforming performance.

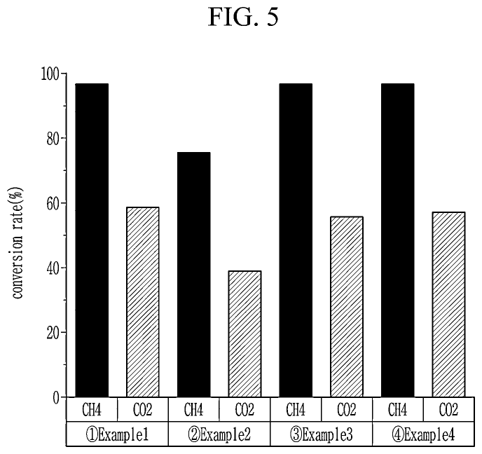

FIG. 5 is a graph showing the results of evaluating the reforming performance of the catalyst structures prepared in Examples 1 to 4.

Referring to FIG. 5, reforming performance according to a coating amount of a catalytic material may be compared. Example 1 exhibits the highest conversion rate of methane and carbon dioxide. Example 2 exhibits that a catalyst coating amount is low for processing the injected reaction gas, and Examples 3 and 4 exhibit slightly deteriorated performance than Example 1 but still high reforming performance.

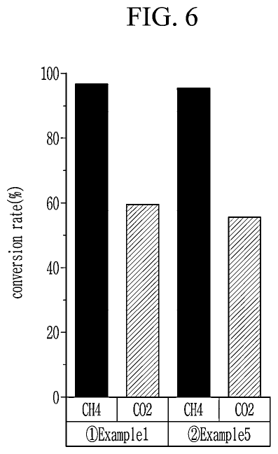

FIG. 6 is a graph showing the results of evaluating the reforming performance of the catalyst structures prepared in Examples 1 and 5.

Referring to FIG. 6, reforming performance according to an Ni content of a catalytic material may be compared. In Example 5, the Ni content is increased to increase reforming performance of the catalyst structure, but there is no significant difference in a conversion rate of the reaction gas. However, a CO₂ conversion rate alone drops by about 3%. Accordingly, the reforming performance is more affected by the substrate material than by the Ni content.

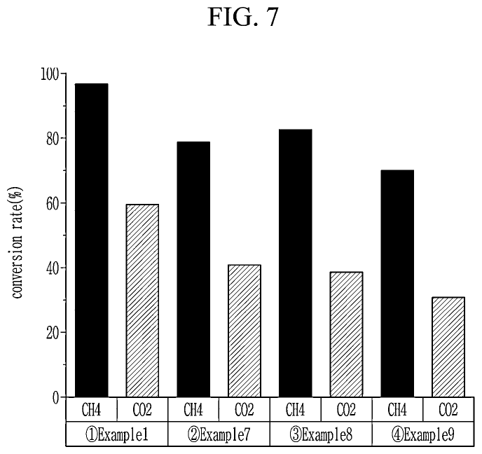

FIG. 7 is a graph showing the results of evaluating the reforming performance of the catalyst structures prepared in Example 1 and Examples 7 to 9.

Referring to FIG. 7, reforming performance according to reactor configuration may be compared. In Example 1, the catalyst structure is configured to be in contact with a reactor tube by matching a diameter of the catalyst structure with an interior diameter of the reactor tube. Herein, there is no channeling.

In Example 7, an apparatus is configured by using a catalyst structure with the same properties as that of Example 1 and a reactor tube with a larger interior diameter than the diameter of the catalyst structure. In Example 7, a gas layer between the catalyst structure and an inner wall of the reactor tube interferes with heat transfer and reduces the reforming performance.

In Example 8, an apparatus is configured by using a catalyst structure with the same properties as that of Example 1 but externally wrapping the catalyst structure with a ceramic mat to fix it onto the inner wall of the reactor tube. In Example 8, the ceramic mat acts as an insulator and reduces external heat transfer and thus deteriorates the reforming performance.

Example 9 uses a catalyst structure with the same properties as that of Example 1 but a reactor tube with a larger interior diameter than a diameter of the catalyst structure. In addition, an apparatus of Example 9 is configured to allow channeling of the reaction gas. Example 9 exhibits deterioration of catalyst performance, compared with Example 7 in which no channeling occurs.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2: substrate
4: cylindrical outer surface
6: upstream end
8: downstream end
10: flow path
12: partition wall
14: catalytic material

What is claimed is:

1. A catalyst structure for preparing synthetic gas, the catalyst structure comprising:
a substrate comprising flow paths partitioned by partition walls; and
catalytic material disposed on a surface of the partition walls of the substrate,
wherein the catalytic material comprises a metal oxide carrier and metal active particles supported on the metal oxide carrier, and
wherein the substrate comprises silicon carbide (SIC), silicon nitride (Si₃N₄), a metallic silicon (Si)-silicon carbide (SiC) composite, a metallic silicon (Si)-silicon nitride (Si₃N₄) composite, or a combination thereof.

2. The catalyst structure of claim 1, wherein the catalytic material is coated on inner walls of the flow paths of the substrate.

3. The catalyst structure of claim 1, wherein the substrate has a honeycomb shape or a monolithic shape.

4. The catalyst structure of claim 1, wherein the catalyst structure has a thermal conductivity of 10 W/mK or more.

5. The catalyst structure of claim 1, wherein the partition walls of the substrate have a plurality of pores.

6. The catalyst structure of claim 5, wherein the partition walls of the substrate have a porosity in a range of 10% to 80%.

7. The catalyst structure of claim 1, wherein the catalytic material is included in an amount in a range of 20 g to 300 g per 1 L of volume of the catalyst structure.

8. The catalyst structure of claim 1, wherein the metal active particles comprise nickel (Ni), cobalt (Co), rhodium (Rh), ruthenium (Ru), iridium (Ir), palladium (Pd), platinum (Pt), gold (Au), iron (Fe), an alloy thereof, or a combination thereof.

9. The catalyst structure of claim 1, wherein the metal oxide carrier comprises alumina (Al₂O₃), silica (SiO₂), magnesia (MgO), magnesium aluminate (MgAl₂O₄), zirconia (ZrO₂), ceria (CeO₂), lantana (La₂O₃), yttria (Y₂O₃), or a combination thereof.

10. The catalyst structure of claim 1, wherein the metal active particles are included in an amount in a range of 5 wt. % to 30 wt. % based on a total weight of the catalytic material.

11. An apparatus for preparing synthetic gas, the apparatus comprising:
a reactor tube comprising a catalyst structure for generating the synthetic gas,
wherein the catalyst structure comprises: (1) a substrate comprising flow paths partitioned by partition walls; and (2) catalytic material disposed on a surface of the partition walls of the substrate,
wherein the catalytic material comprises a metal oxide carrier and metal active particles supported on the metal oxide carrier,
wherein the substrate comprises silicon carbide (SIC), silicon nitride (Si₃N₄), a metallic silicon (Si)-silicon carbide (SIC) composite, a metallic silicon (Si)-silicon nitride (Si₃N₄) composite, or a combination thereof,
wherein the flow paths of the substrate of the catalyst structure are arranged along a longitudinal direction of the reactor tube, and
wherein a reaction gas is configured to pass through channels of the catalyst structure to generate the synthetic gas.

12. The apparatus of claim 11, wherein the catalyst structure is in direct contact with an inner wall of the reactor tube.

13. The apparatus of claim 11, wherein the reaction gas is configured to not pass between the catalyst structure and an inner wall of the reactor tube.

14. A method for preparing a synthetic gas, the method comprising:
injecting a reaction gas and an oxidizing agent into flow paths of a catalyst structure; and
reforming the reaction gas through an endothermic reaction to prepare the synthetic gas,
wherein the catalyst structure comprises a substrate having the flow paths partitioned by partition walls; and catalytic material disposed on a surface of the partition walls of the substrate,
wherein the catalytic material comprises a metal oxide carrier and metal active particles supported on the metal oxide carrier, and
wherein the substrate comprises silicon carbide (SIC), silicon nitride (Si₃N₄), a metallic silicon (Si)-silicon carbide (SiC) composite, a metallic silicon (Si)-silicon nitride (Si₃N₄) composite, or a combination thereof.

15. The method of claim 14, wherein the reaction gas comprises a C1 to C20 alkane, a C1 to C20 alkene, a C1 to C20 alkyne, ammonia (NH₃), formaldehyde (HCO₂H), methanol (CH₃OH), or a combination thereof.

16. The method of claim 14, wherein the oxidizing agent comprises carbon dioxide (CO₂), steam (H₂O), oxygen (O₂), or a combination thereof.
